(19) United States
(12) Patent Application Publication
(10) Pub. No.: US 2014/0152592 A1
(43) Pub. Date: Jun. 5, 2014

(54) INFORMATION PROCESSING APPARATUS, CONTROL METHOD OF INFORMATION PROCESSING APPARATUS AND COMPUTER-READABLE MEDIUM

(71) Applicant: Kabushiki Kaisha Toshiba, Tokyo (JP)

(72) Inventor: Hideki Yoshida, Tokyo (JP)

(73) Assignee: Kabushiki Kaisha Toshiba, Tokyo (JP)

(21) Appl. No.: 14/035,057

(22) Filed: Sep. 24, 2013

(30) Foreign Application Priority Data
Nov. 30, 2012 (JP) 2012-263067

(51) Int. Cl. G06F 3/041

(52) U.S. Cl. CPC G06F 3/041
USPC 345/173

(57) ABSTRACT

An information processing apparatus includes a screen on which software keys are displayed, a touch detector, a key detector, a key input time acquiring module, and a touch input restricting module. The touch detector detects a touch manipulation of a software key. The key detector detects a key manipulation on an input device in which mechanical keys are arranged. The key input time acquiring module acquires a detection time of the key manipulation, and stores the acquired time in a memory. The touch input restricting module acquires a detection time of the touch manipulation, reads the detection time of the key manipulation from the memory, and restricts acceptance of the touch manipulation according to whether or not a time from the detection time of the key manipulation to the detection time of the touch manipulation is longer than or equal to a first prescribed time.

### CROSS-REFERENCE TO RELATED APPLICATION(S)

This application is based upon and claims the benefit of priority from Japanese Patent Application No. 2012-263067, filed Nov. 30, 2012; the entire contents of which are incorporated herein by reference.

### FIELD

Embodiments described herein relate generally to an information processing apparatus, a control method of an information processing apparatus, and a computer-readable medium.

### BACKGROUND

Conventionally, in information processing apparatus such as personal computers, a keyboard in which mechanical keys are arranged is used for character input etc. On the other hand, in recent years, such information processing apparatus as smartphones and tablet terminals have increasingly come to use a virtual keyboard in which virtual keys are displayed on a touch screen and a user is allowed to input characters etc. by making touch manipulations on them.

An information processing apparatus which is equipped with a virtual keyboard may be used in such a manner that a keyboard in which mechanical keys are arranged is connected to it. In such an information processing apparatus which is equipped with both of a virtual keyboard and a mechanical keyboard, the mechanical keyboard is located close to the virtual keyboard, that is, a touch screen.

Where a mechanical keyboard is located close to a touch screen, the following problems arises. Since fingers etc. exist close to the touch screen when the mechanical keyboard is manipulated, a finger or the like may touch the touch screen to cause an erroneous recognition that a touch manipulation has been made.

### BRIEF DESCRIPTION OF THE DRAWINGS

FIG. 1 shows the configuration of an information processing apparatus according to a first embodiment.

FIG. 2 shows an example display on a touch screen in the case where only the information processing apparatus is used.

FIG. 3 shows the electrical configuration of the information processing apparatus according to the first embodiment.

FIG. 4 is a flowchart of a process for restricting acceptance of a touch manipulation of an SW key.

FIG. 5 shows the electrical configuration of an information processing apparatus according to a second embodiment.

FIG. 6 is a flowchart of a process for restricting acceptance of a touch manipulation of an SW key.

FIG. 7 shows the electrical configuration of an information processing apparatus according to a third embodiment.

FIG. 8 is a flowchart of a process for restricting acceptance of a touch manipulation of an SW key.

FIG. 9 shows the electrical configuration of an information processing apparatus according to a fourth embodiment.

FIG. 10 is a flowchart of a process for restricting acceptance of a touch manipulation of an SW key.

### DETAILED DESCRIPTION

According to one embodiment, an information processing apparatus includes a screen, a touch detector, a key detector, a key input time acquiring module and a touch input restricting module. Software keys are displayed on the screen. The touch detector is configured to detect a touch manipulation of a software key. The key detector is configured to detect a key manipulation on an input device in which mechanical keys are arranged. The key input time acquiring module is configured to acquire, in response to the detection of the key manipulation by the key detector, a time of the detection of the key manipulation, and to store the acquired time in a memory. The touch input restricting module is configured (i) to acquire a time of the detection of the touch manipulation in response to the detection of the touch manipulation by the touch detector, (ii) to read the time of the detection of the key manipulation from the memory and (iii) to restrict acceptance of the touch manipulation according to whether or not a time from the time of the detection of the key manipulation to the time of detection of the touch manipulation is longer than or equal to a first prescribed time.

Various Embodiments will be described hereinafter with reference to the accompanying drawings.

### Embodiment 1

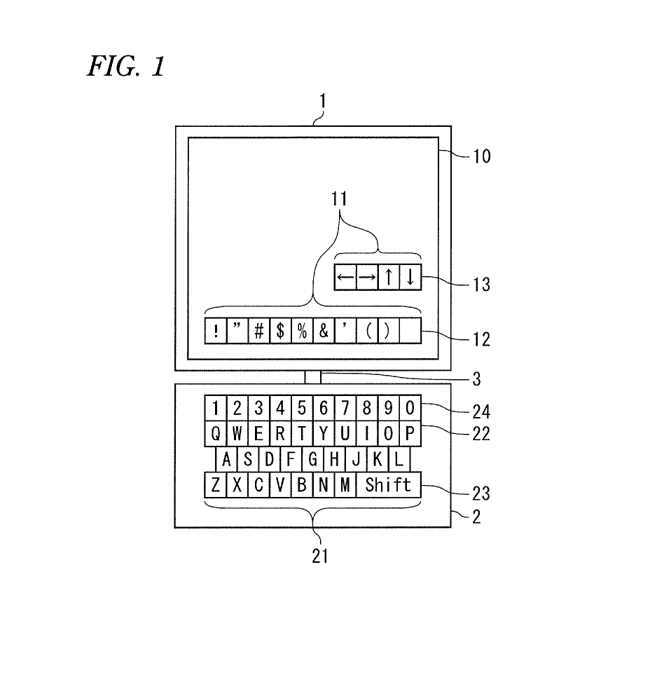

First, the configuration of an information processing apparatus 1 according to a first embodiment will be described with reference to FIGS. 1-3.

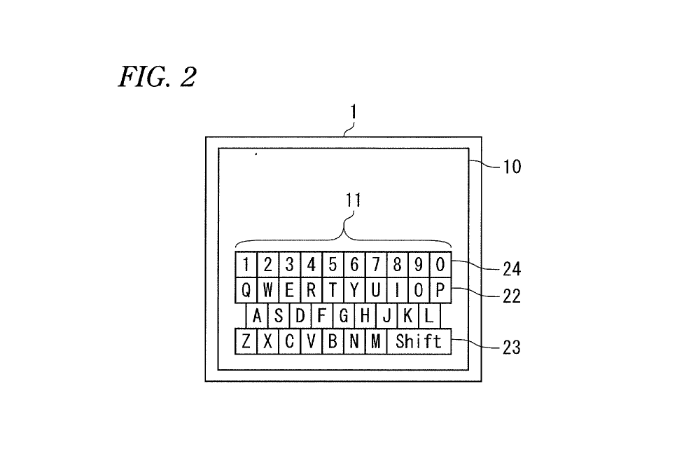

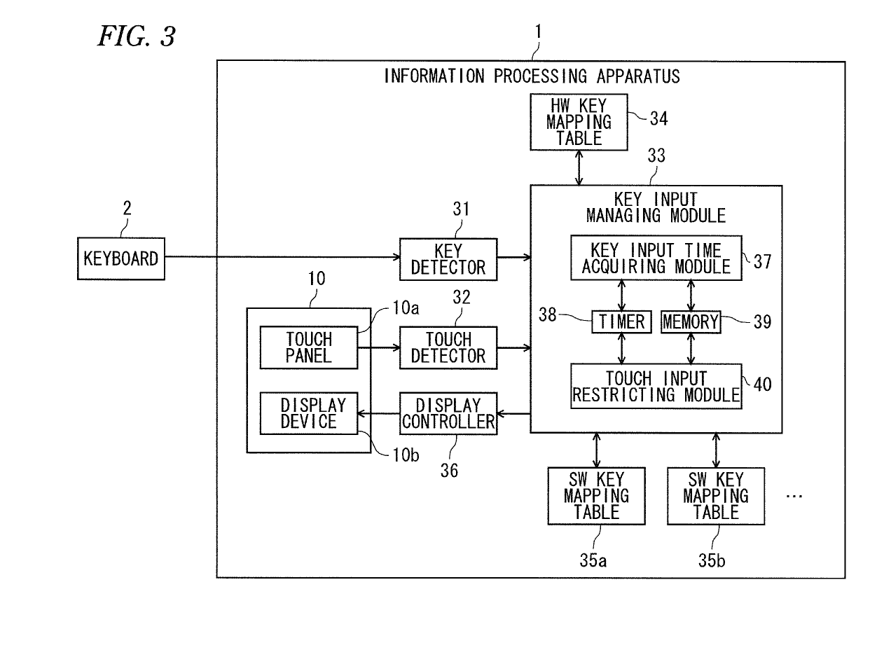

FIG. 1 shows the configuration of the information processing apparatus 1 according to the first embodiment. FIG. 2 shows an example display on a touch screen 10 in the case where only the information processing apparatus 1 is used. FIG. 3 shows the electrical configuration of the information processing apparatus 1 according to the first embodiment.

As shown in FIG. 1, the information processing apparatus 1 is an information terminal such as a smartphone or a tablet terminal, and a keyboard 2 for character input is disposed close to the information processing apparatus 1. The information processing apparatus 1 is configured to attach to the keyboard 2 via a connection module 3 in a detachable manner The connection module 3 is a wired connection module using USB, for example However, the invention is not limited to such a case and a wireless connection module may be used which uses Bluetooth (registered trademark), for example.

The information processing apparatus 1 has the touch screen 10 which consists of a touch panel 10a (see FIG. 3) and a display device 10b (see FIG. 3) such as a liquid crystal display or an organic EL display. Virtual keys (hereinafter referred to as SW keys (software keys)) 11 are displayed on the touch screen 10, and characters etc. can be input by making touch manipulations on the SW keys 11. In this embodiment, the SW keys 11 are configured to be plural symbol keys 12 and plural arrow keys 13.

The keyboard 2 as an input device has mechanical keys (hereinafter referred to HW keys (hardware keys) 21 which are configured to be, in this embodiment, plural alphabet keys 22, a shift key 23 and plural numeral keys 24.

For the sake of simplicity of description, only a minimum necessary number of keys are shown in FIG. 1; actually, additional SW keys 11 and HW keys 21 such function keys are also arranged on the information processing apparatus 1 and the keyboard 2.

The information processing apparatus 1 can be used singly. Where the information processing apparatus 1 is singly used, as shown in FIG. 2, alphabet keys 22, a shift key 23 and numeral keys 24 are displayed as SW keys 11 on the touch screen 10.

As shown in FIG. 3, the information processing apparatus 1 is equipped with, in addition to the touch screen 10, a key detector 31, a touch detector 32, a key input managing module 33, a HW key mapping table 34, plural SW key mapping tables 35a, 35b, etc., and a display controller 36.

The key input managing module 33 has a key input time acquiring module 37, a timer 38, a memory 39 and a touch input restricting module 40. Each of the function blocks of the key input managing module 33 may be implemented as a program.

When an HW key of the keyboard 2 is pushed, the key detector 31 detects code information corresponding to the pushed HW key 21 and outputs it to the key input managing module 33. Pieces of code information and pieces of character information are stored in the HW key mapping table 34 so as to be correlated with each other.

When receiving code information from the key detector 31, the key input managing module 33 refers to the HW key mapping table 34 and reads character information corresponding to the received code information from it. The read-out character information is displayed on the touch screen 10 under the control of the display controller 36.

When an SW key 11 displayed on the touch panel 10a of the touch screen 10 is pushed, the touch detector 32 detects coordinate information and level information corresponding to the pushed SW key 11 and outputs them to the key input managing module 33.

Pieces of coordinate information on the touch screen 10 and pieces of character information corresponding to the coordinate information are correlated with each other to store in each of the SW key mapping tables 35a, 35b, etc. The SW key mapping tables 35a, 35b, etc. are different kinds of tables for display of the SW keys 11 on the touch panel 10. For example, the SW key mapping tables 35a, 35b, etc., to be referred, are changed based on whether or not the keyboard 2 is connected to the information processing apparatus 1.

When receiving coordinate information and level information from the touch detector 32, the key input managing module 33 reads out character information corresponding to the received coordinate information by referring to the SW key mapping table 35a or 35b depending on a connection state of the keyboard 2. The read-out character information is displayed on the touch screen 10 under the control of the display controller 36. As described later, acceptance of a touch manipulation of an SW key 11 is restricted by the touch input restricting module 40.

When an HW key 21 of the keyboard 2 is pushed, the key input time acquiring module 37 acquires a time of the push of the HW key 21 from the timer 38 and stores the acquired time in the memory 39. Every time an HW key 21 is pushed (manipulated), the key input time acquiring module 37 acquires a manipulation time from the timer 38 and stores it in the memory 39. That is, a time when an HW key 21 was manipulated last is always stored in the memory 39.

When a touch manipulation is performed on an SW key 11 displayed on the touch screen 10, the touch input restricting module 40 acquires a time of the touch manipulation from the timer 38 and reads the HW-key-last-manipulated time from the memory 39. Then, the touch input restricting module 40 judges whether the time from the HW-key-last-manipulated time to the time of the touch manipulation of the SW key 11 is longer than or equal to a prescribed time, and restricts acceptance of the touch manipulation of the SW key 11 according to the judgment result.

More specifically, if the time from the HW-key-last-manipulated time to the time of the touch manipulation of the SW key 11 is longer than or equal to 1 sec, for example, the touch input restricting module 40 makes the touch manipulation valid (e.g., displays character information corresponding to the touch-manipulated SW key 11 on the touch screen 10). On the other hand, if the time from the HW-key-last-manipulated time to the time of the touch manipulation of the SW key 11 is shorter than 1 sec, the touch input restricting module 40 makes the touch manipulation invalid (e.g., disregards the touch manipulation).

The manner of restriction of acceptance of a touch manipulation is not limited to the above. When a user touches the touch screen 10 unintentionally with a finger or the like while manipulating the HW keys 21, a level that is detected by the touch detector 32 would be low. Utilizing this fact, the sensitivity of recognition of a touch manipulation may be lowered by increasing a touch manipulation recognition threshold value for levels detected by the touch detector 32. This makes it possible to recognize only touch manipulations which have pushed the touch screen 10 definitely and to prevent recognition of erroneous manipulations which have touched the touch screen 10 softly.

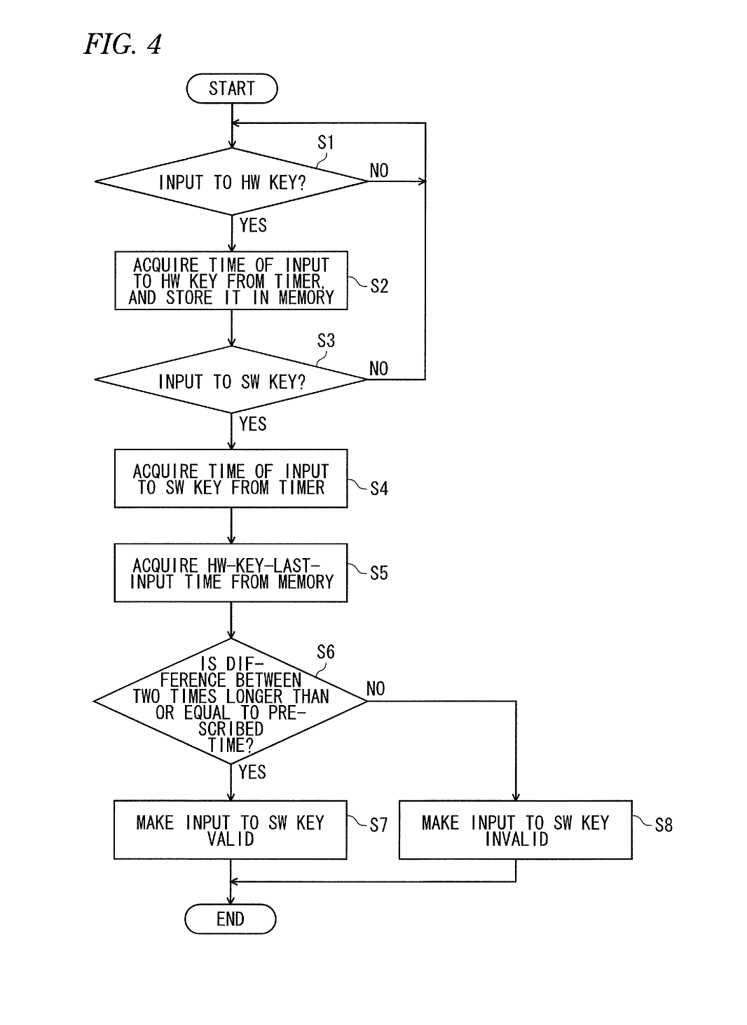

Next, a description will be made of how the above-configured information processing apparatus 1 operates. FIG. 4 is a flowchart of a process for restricting acceptance of a touch manipulation of an SW key 11.

First, at step S1, the key detector 31 detects whether an input to an HW key 21 has occurred or not. If it is detected that no input to an HW key 21 has occurred, the process returns to step S1. On the other hand, if it is detected that an input to an HW key 21 has occurred, at step S2 the key input time acquiring module 37 acquires a time of the input to the HW key 21 from the timer 38 and stores it in the memory 39.

At step S3, the touch detector 32 detects whether an input to an SW key 11 has occurred or not. If it is detected that no input to an SW key 11 has occurred, the process returns to step S1. On the other hand, if it is detected that an input to an has occurred, at step S4 the touch input restricting module 40 acquires a time of the input to the SW key 11 from the timer 38. At step S5, the touch input restricting module 40 acquires the HW-key-last-input time from the memory 39.

At step S6, the touch input restricting module 40 judges whether the time from the HW-key-last-input time to the time of the input to the SW key 11 is longer than or equal to the prescribed time. If the difference between the two times is longer than or equal to the prescribed time, at step S7 the touch input restricting module 40 makes the input to the SW key 11 valid. On the other hand, if the difference between the two times is shorter than the prescribed time, at step S8 the touch input restricting module 40 makes the input to the SW key 11 invalid. Then, the process is finished.

In the above-described information processing apparatus 1, when an SW key 11 displayed on the touch screen 10 is manipulated, it is judged whether or not the prescribed time has elapsed from the HW-key-last-manipulated time and acceptance of the manipulation of the SW key 11 is restricted according to the judgment result (i.e., the manipulation is made valid or invalid). For example, if a user erroneously touches an SW key 11 on the touch screen 10 with a finger or the like while manipulating the HW keys 21 of the keyboard 2, the prescribed time has not elapsed yet from the HW-key-last-manipulated time to the time of the touch (manipulation) to the SW key 11. In this case, in the information processing apparatus 1, the manipulation of the SW key 11 is made invalid, that is, it is not recognized as a valid manipulation.

In this manner, the information processing apparatus 1 according to the embodiment can reduce the probability of occurrence of an erroneous manipulation of a virtual keyboard.

Although the embodiment is directed to a manipulation on a virtual keyboard as an example touch manipulation, there are other kinds of touch manipulations such as an icon tap, click, and drag, and a pinch. The information processing apparatus 1 according to the embodiment is also effective in reducing the probability of erroneously making any of those kinds of touch manipulations.

### Embodiment 2

Next, a second embodiment will be described. The second embodiment is directed to an information processing apparatus in which acceptance of a manipulation of an SW key 11 is restricted by detecting a position of a manipulated HW key 21.

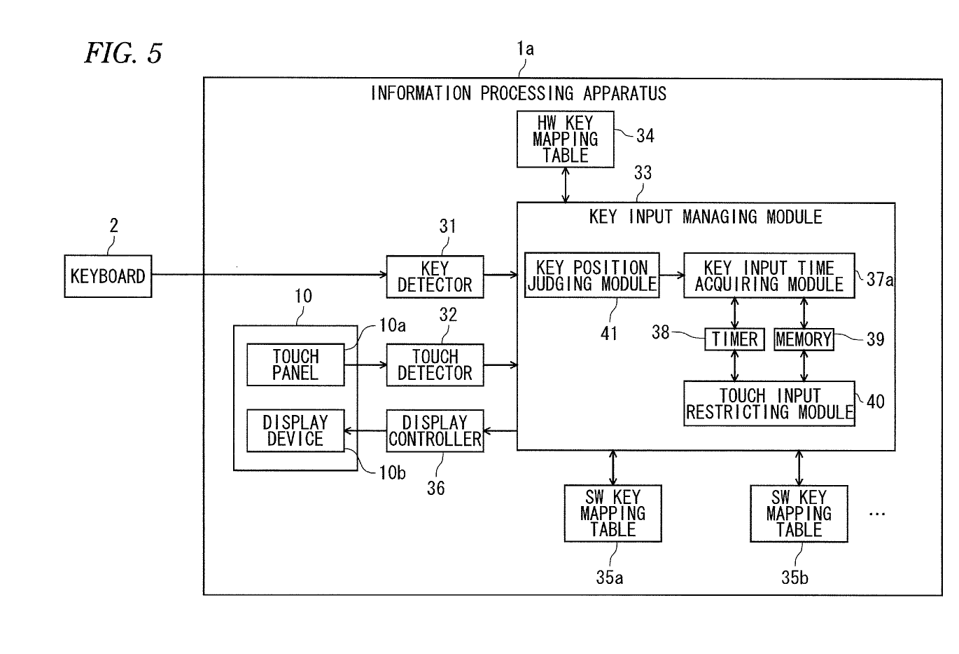

FIG. 5 shows the electrical configuration of an information processing apparatus la according to the second embodiment. Modules etc. shown in FIG. 5 having the same ones in FIG. 3 are given the same reference symbols as the latter, and will not be described in detail.

As shown in FIG. 5, in the information processing apparatus 1a according to the second embodiment, a key input time acquiring module 37a is used in place of the key input time acquiring module 37 used in the first embodiment and a key position judging module 41 is added.

The key position judging module 41 detects a position of a pushed HW key 21 on the basis of corresponding code information that is detected by the key detector 31. Then, the key position judging module 41 judges whether or not the position of the pushed HW key 21 is close to the touch screen 10, and outputs a judgment result to the key input time acquiring module 37a.

If, for example, a numeral key 24 of the HW keys 21 is pushed, the key position judging module 41 judges that the pushed HW key 21 is close to the touch screen 10. If an alphabet key 22 or a shift key 23 of the HW keys 21 is pushed, the key position judging module 41 judges that the pushed HW key 21 is not close to the touch screen 10.

If the judgment result of the key position judging module 41 is that the pushed HW key 21 is close to the touch screen 10, the key input time acquiring module 37a acquires a time when the HW key 21 was pushed from the timer 38 and stores it in the memory 39. On the other hand, if the judgment result of the key position judging module 41 is that the pushed HW key 21 is not close to the touch screen 10, the key input time acquiring module 37a does not acquire a time when the HW key 21 was pushed.

If a touch manipulation is performed on an SW switch 11 displayed on the touch screen 10, the touch input restricting module 40 refers to the HW-key-last-manipulated time which is stored in the memory 39 and restricts acceptance of the touch manipulation.

The manner of restriction of acceptance of a touch manipulation is not limited to the above. For example, the sensitivity of recognition of a touch manipulation may be lowered by setting larger a touch manipulation recognition threshold value for levels detected by the touch detector 32 as a manipulated HW key 21 is closer to the touch screen 10. More specifically, the threshold value is not changed if the manipulated HW key 21 is an alphabet key 22, and is increased if the manipulated HW key 21 is a numeral key 24. In this manner, the probability of occurrence of an erroneous touch manipulation of an SW key 11 after a manipulation of an HW key 21 that is close to the touch screen 10 can be suppressed.

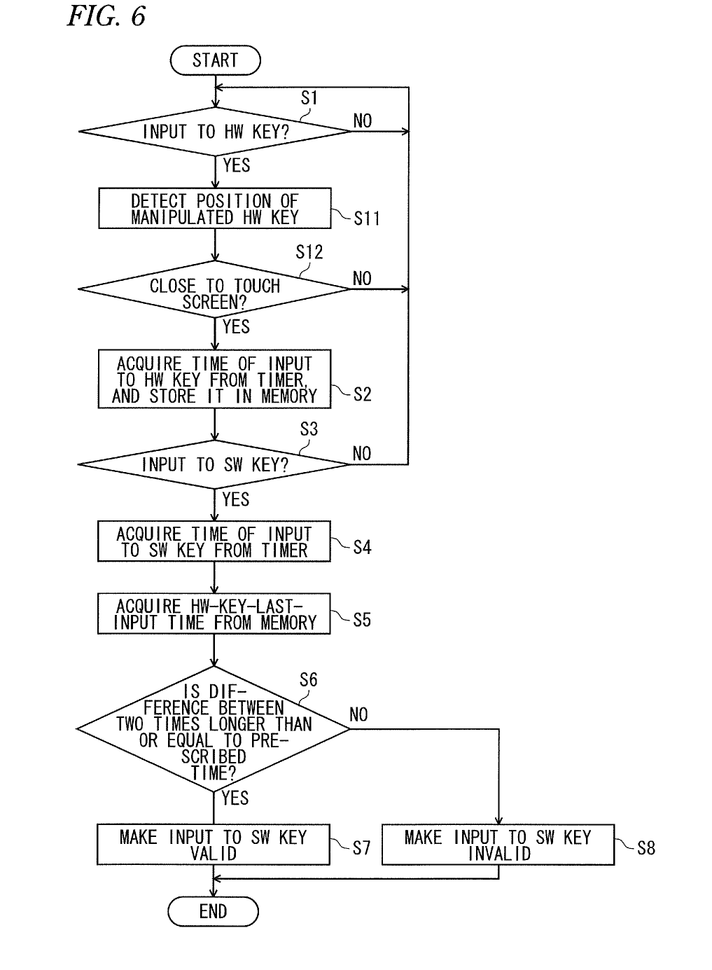

Next, a description will be made of how the above-configured information processing apparatus 1a operates. FIG. 6 is a flowchart of a process for restricting acceptance of a touch manipulation of an SW key 11. Steps shown in FIG. 6 that have the same steps in FIG. 4 are given the same reference symbols as the latter, and will not be described in detail.

If it is detected at step S1 that an input to an HW key 21 has occurred, at step S11 the key position judging module 41 detects a position of the manipulated HW key 21. At step S12, the key position judging module 41 judges whether or not the position of the manipulated HW key 21 is close to the touch screen 10. If the position of the manipulated HW key 21 is not close to the touch screen 10, the process returns to step S1. On the other hand, if the position of the manipulated HW key 21 is close to the touch screen 10, at step S2 a time of the input to the HW key 21 is acquired from the timer 38 and stored in the memory 39. The other steps S3-S8 are the same as in the process of FIG. 4.

As described above, in the information processing apparatus la, a position of a manipulated HW key 21 is detected. Only if the detected position is close to the touch screen 10, a time of the manipulation of the HW key 21 is stored and acceptance of a touch manipulation is restricted. As a result, in the information processing apparatus la according to this embodiment, acceptance of a touch manipulation on the touch screen 10 can be restricted only after a manipulation of an HW key 21 that is close to the touch screen 10. This prevents a true touch manipulation from being recognized as an erroneous manipulation.

### Embodiment 3

Next, a third embodiment will be described. The third embodiment is directed to an information processing apparatus in which acceptance of a manipulation of an SW key 11 is restricted by detecting a position of the manipulated SW key 11.

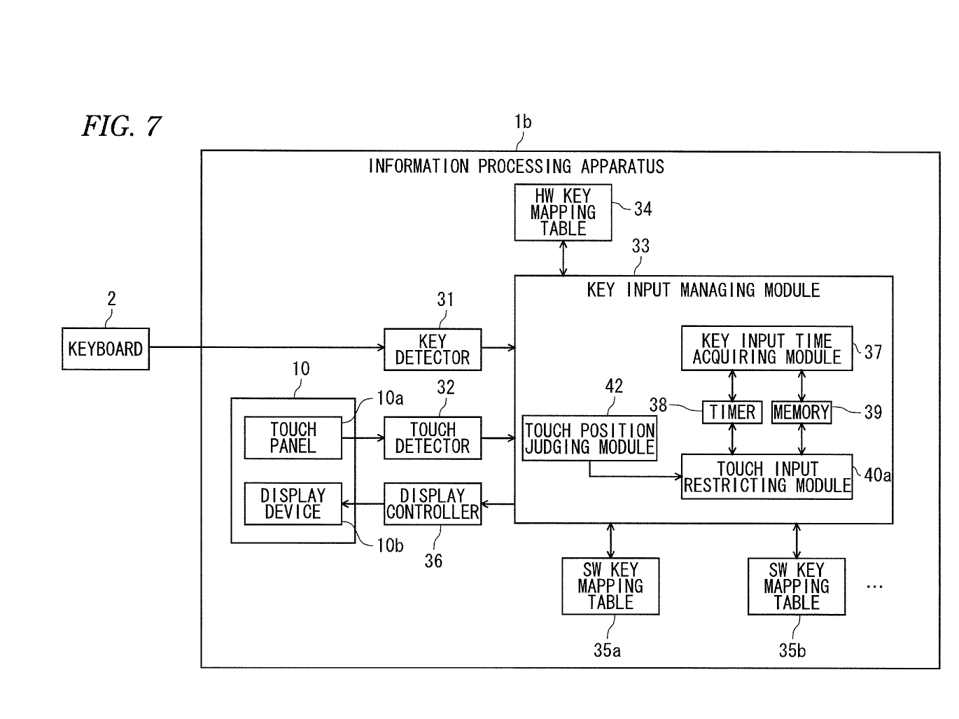

FIG. 7 shows the electrical configuration of an information processing apparatus 1b according to the third embodiment. Modules etc. shown in FIG. 7 having the same ones in FIG. 3 are given the same reference symbols as the latter, and will not be described in detail.

As shown in FIG. 7, in the information processing apparatus 1b according to the third embodiment, a touch input restricting module 40a is used in place of the touch input restricting module 40 used in the first embodiment and a touch position judging module 42 is added.

The touch position judging module 42 detects a position of a pushed SW key 11 on the basis of coordinate information that is detected by the touch detector 32. Then, the touch position judging module 42 judges whether or not the position of the pushed SW key 11 is close to the HW keys 21, and outputs a judgment result to the touch input restricting module 40a.

For example, the touch position judging module 42 judges that the pushed SW key 11 is close to the HW keys 21 if a symbol key 12 of the SW keys 11 is pushed, and judges that the pushed SW key 11 is not close to the HW keys 21 if an arrow key 13 of the SW keys 11 is pushed.

The touch input restricting module 40a restricts acceptance of the touch manipulation of the SW key 11 according to the judgment result supplied from the touch position judging module 42. More specifically, if the touch position judging module 42 judges that the pushed SW key 11 is close to the HW keys 21, the touch input restricting module 40a refers to the HW-key-last-manipulated time which is stored in the memory 39 and makes the touch manipulation of the SW key 11 valid or invalid. On the other hand, if the touch position judging module 42 judges that the pushed SW key 11 is not close to the HW keys 21, the touch input restricting module 40a makes the touch manipulation of the SW key 11 valid.

The manner of restriction of acceptance of a touch manipulation is not limited to the above. For example, the sensitivity of recognition of a touch manipulation may be lowered by setting larger a touch manipulation recognition threshold value for levels detected by the touch detector 32 as a manipulated SW key 11 is closer to the HW keys 21. More specifically, the threshold value is not changed if the manipulated SW key 11 is an arrow key 13, and is increased if the manipulated SW key 11 is a symbol key 12. In this mariner, the probability of occurrence of an erroneous touch manipulation of an SW key 11 that is close to the HW keys 21 can be suppressed.

Another method for restricting acceptance of a touch manipulation is as follows. A distance between a manipulated SW key 11 and the HW keys 21 is calculated. Acceptance of a touch manipulation is restricted according to this distance information.

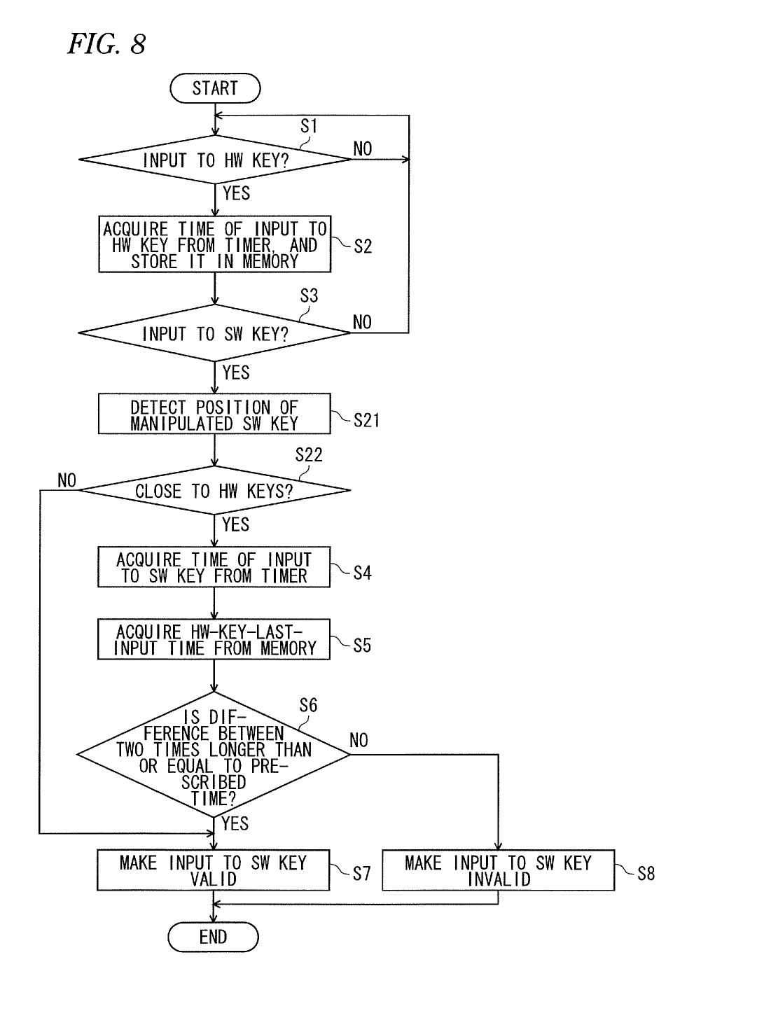

Next, a description will be made of how the above-configured information processing apparatus 1b operates. FIG. 8 is a flowchart of a process for restricting acceptance of a touch manipulation of an SW key 11. Steps shown in FIG. 8 that have the same steps in FIG. 4 are given the same reference symbols as the latter, and will not be described in detail.

If it is detected at step S3 that an input to an SW key 11 has occurred, at step S21 the touch position judging module 42 detects a position of the manipulated SW key 11. At step S22, the touch position judging module 42 judges whether or not the position of the manipulated SW key 11 is close to the HW keys 21. If the position of the manipulated SW key 11 is not close to the HW keys 21, the process moves to step S7, where the input to the SW key 11 is made valid. Then, the process is finished. On the other hand, if the position of the manipulated SW key 11 is close to the HW keys 21, steps S4-S8 are executed which are the same as in the process of FIG. 4. Then, the process is finished.

As described above, in the information processing apparatus 1b, a position of a manipulated SW key 11 is detected. Only if the detected position is close to the HW keys 12, acceptance of the touch manipulation of the SW key 11 is restricted. As a result, in the information processing apparatus lb according to this embodiment, acceptance of a touch manipulation of an SW key 11 can be restricted only if the manipulated SW key 11 is close to the HW keys 21. This prevents a true touch manipulation from being recognized as an erroneous manipulation.

### Embodiment 4

Next, a fourth embodiment will be described. An erroneous manipulation on the touch screen 10 may occur before, rather than after, manipulations of HW keys 21. The fourth embodiment is directed to an information processing apparatus which restricts acceptance of a manipulation on the touch screen 10 that occurs before manipulations of HW keys 21.

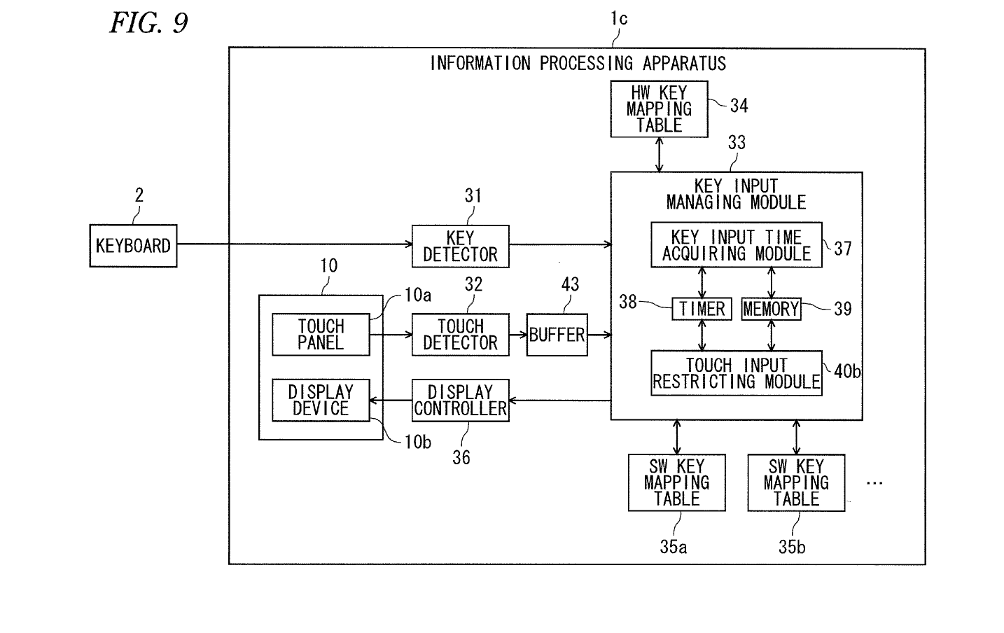

FIG. 9 shows the electrical configuration of an information processing apparatus 1c according to the fourth embodiment. Modules etc. shown in FIG. 9 having the same ones in FIG. 3 are given the same reference symbols as the latter, and will not be described in detail.

As shown in FIG. 9, in the information processing apparatus 1c according to the fourth embodiment, a touch input restricting module 40b is used in place of the touch input restricting module 40 used in the first embodiment and a buffer 43 is added.

The buffer 43 which serves as a delay module holds, for a prescribed time (e.g., 1 sec), coordinate information and level information that have been detected by the touch detector 32 as corresponding to a pushed SW key 11, and then outputs them to the key input managing module 33. That is, when a touch manipulation is made on an SW key 11 displayed on the touch screen 10, information relating to the touch manipulation is input to the key input managing module 33 after a delay of the prescribed time.

When receiving the information relating to the touch manipulation from the buffer 43 after the delay of the prescribed time, the touch input restricting module 40b acquires a time of the reception of the information relating to the touch manipulation from the timer 38 and reads the HW-key-last-manipulated time from the memory 39. The touch input restricting module 40b judges whether or not HW keys 21 were manipulated within a prescribed time on the basis of the reception time of the information relating to the touch manipulation that is delayed by the prescribed time and the HW-key-last-manipulated time, and restricts acceptance of the touch manipulation of the SW key 11.

More specifically, the touch input restricting module 40b makes valid a touch manipulation of an SW key 11 displayed on the touch screen 10 if no HW key 21 is manipulated for 1 sec, for example, after the touch manipulation of the SW key 11. On the other hand, the touch input restricting module 40b makes a touch manipulation of an SW key 11 invalid if HW keys 21 are manipulated within 1 sec, for example, from the touch manipulation of the SW key 11.

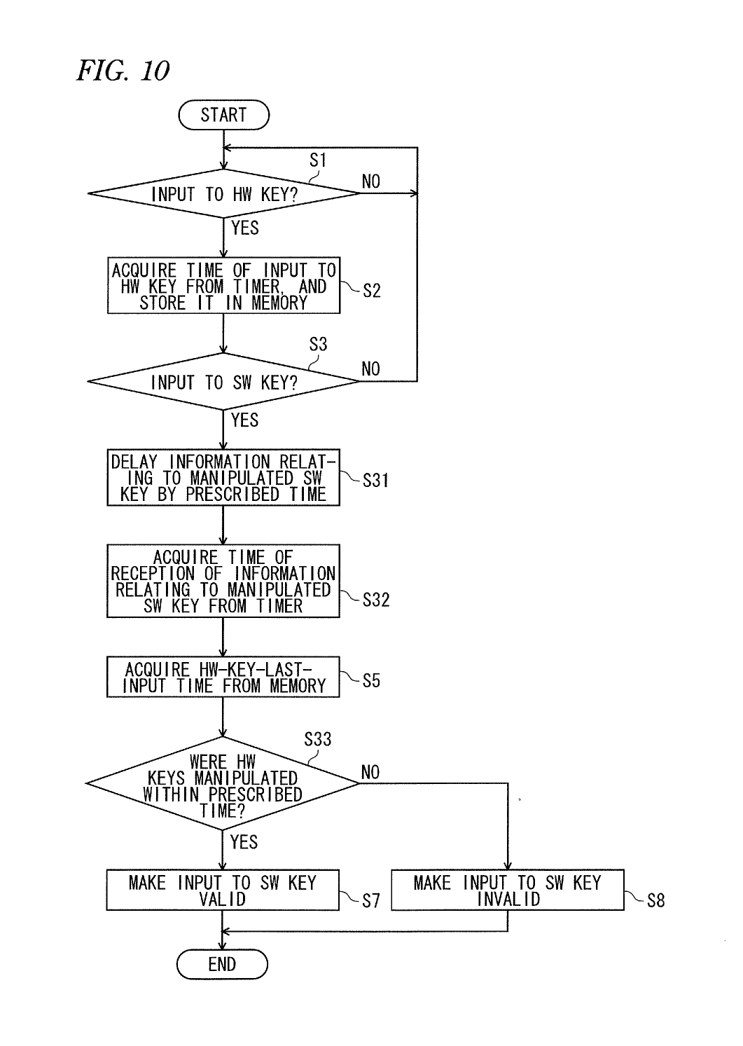

Next, a description will be made of how the above-configured information processing apparatus 1c operates. FIG. 10 is a flowchart of a process for restricting acceptance of a touch manipulation of an SW key 11. Steps shown in FIG. 10 that have the same steps in FIG. 4 are given the same reference symbols as the latter, and will not be described in detail.

If it is detected at step S3 that an input to an SW key 11 has occurred, at step S31 information relating to the manipulated SW key 11 is delayed by the prescribed time by the buffer 43. At step S32, the touch input restricting module 40b acquires, from the timer 38, a time of reception of the information relating to the manipulated SW key 11 which has been delayed by the prescribed time. At step S5, the touch input restricting module 40b acquires the HW-key-last-input time from the memory 39. At step S33, the touch input restricting module 40b judges whether or not HW keys 21 were manipulated within the prescribed time. If no HW key 21 was manipulated within the prescribed time (S33: no), at step S7 the input to the SW key 11 is made valid. Then, the process is finished. On the other hand, if HW keys 21 were manipulated within the prescribed time (S33: yes), at step S8, the input to the SW key 11 is made invalid. Then, the process is finished.

As described above, in the information processing apparatus 1c according to this embodiment, when an SW key 11 is manipulated, acceptance of the touch manipulation of the SW key 11 is restricted by delaying information relating to the manipulated SW key 11 by the prescribed time and judging whether or not HW keys 21 of the keyboard 2 were manipulated within the prescribed time. As a result, the information processing apparatus 1c according to this embodiment can prevent an erroneous manipulation from being made on the touch screen 10 before manipulations of HW keys 21.

All or part of a program for causing each of the above-described operations is recorded or stored as a computer program product in, for example, a portable medium such as a flexible disk or a CD-ROM, a storage device such as a hard disk drive. The program is read by a computer, whereby all or part of the operation is performed. Alternatively, all or part of the program may be delivered or provided over a communication network. A user can easily implement the information processing apparatus or the control method according to each embodiment by downloading the program over a communication network and installing it in a computer or installing the program in a computer from a recording medium.

The steps of each of the flowcharts described in this specification may be executed in different order than shown in the flowchart or in different order each time they are executed, and part of them may be executed simultaneously as long as the intended operation is attained.

Although the several embodiments of the invention have been described above, they are just examples and should not be construed as restricting the scope of the invention. Each of these novel embodiments may be practiced in other various forms, and part of it may be omitted, replaced by other elements, or changed in various manners without departing from the spirit and scope of the invention. These modifications are also included in the invention as claimed and its equivalents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a screen on which software keys are displayed;
a touch detector configured to detect a touch manipulation of a software key;
a key detector configured to detect a key manipulation on an input device in which mechanical keys are arranged;
a key input time acquiring module configured to acquire, in response to the detection of the key manipulation by the key detector, a time of the detection of the key manipulation, and to store the acquired time in a memory; and
a touch input restricting module configured (i) to acquire a time of the detection of the touch manipulation in response to the detection of the touch manipulation by the touch detector, (ii) to read the time of the detection of the key manipulation from the memory and (iii) to restrict acceptance of the touch manipulation according to whether or not a time from the time of the detection of the key manipulation to the time of detection of the touch manipulation is longer than or equal to a first prescribed time.

2. The information processing apparatus of claim 1, further comprising:
a key position judging module configured to detect a position of a manipulated mechanical key of the input device when a key manipulation is performed, and to judge whether or not the detected position of the manipulated mechanical key is close to the screen,
wherein the key input time acquiring module acquires a time of the detection of the key manipulation and stores the acquired time in the memory when the key position judging module judges that the detected position of the manipulated mechanical key is close to the screen.

3. The information processing apparatus of claim 1, further comprising:
a touch position judging module configured to detect a position of a manipulated software key displayed on the screen when a touch manipulation is performed, and to judge whether or not the detected position of the manipulated software key is close to the mechanical keys,
wherein the touch input restricting module restricts acceptance of the touch manipulation according to a judgment result of the touch position judging module.

4. The information processing apparatus of claim 1, further comprising:
a delay module configured to delay acceptance of the touch manipulation by a second prescribed time,
wherein the touch input restricting module judges whether or not the key manipulation is performed within the second prescribed time, and restricts acceptance of the touch manipulation according to a judgment result.

5. A control method of an information processing apparatus comprising:
detecting a touch manipulation of a software key which is displayed on a screen;
detecting a key manipulation on an input device in which mechanical keys are arranged;
acquiring a time of the detection of the key manipulation in response to the detection of the key manipulation;
storing the acquired time in a memory;
acquiring a time of the detection of the touch manipulation in response to the detection of the touch manipulation;
reading the time of the detection of the key manipulation from the memory; and
restricting acceptance of the touch manipulation according to whether or not a time from the time of the detection of the key manipulation to the time of detection of the touch manipulation is longer than or equal to a first prescribed time.

6. The control method of an information processing apparatus of claim 5, further comprising:
detecting a position of a manipulated mechanical key of the input device when a key manipulation is performed;
judging whether or not the detected position of the manipulated mechanical key is close to the screen;
acquiring a time of the detection of the key manipulation when the detected position of the manipulated mechanical key is judged to be close to the screen; and
storing the acquired time in the memory.

7. The control method of an information processing apparatus of claim 5, further comprising:
detecting a position of a manipulated software key displayed on the screen when a touch manipulation is performed;
judging whether or not the detected position of the manipulated software key is close to the mechanical keys; and
restricting acceptance of the touch manipulation according to a judgment result of the judged touch position.

8. The control method of an information processing apparatus of claim 5, further comprising:
delaying acceptance of the touch manipulation by a second prescribed time;
judging whether or not the key manipulation is performed within the second prescribed time; and
restricting acceptance of the touch manipulation according to a judgment result.

9. A non-transitory computer-readable medium storing a program that causes a computer to execute information processing comprising:
detecting a touch manipulation of a software key which is displayed on a screen;
detecting a key manipulation on an input device in which mechanical keys are arranged;
acquiring a time of the detection of the key manipulation in response to the detection of the key manipulation;
storing the acquired time in a memory;
acquiring a time of the detection of the touch manipulation in response to the detection of the touch manipulation;
reading the time of the detection of the key manipulation from the memory; and
restricting acceptance of the touch manipulation according to whether or not a time from the time of the detection of the key manipulation to the time of detection of the touch manipulation is longer than or equal to a first prescribed time.

10. The non-transitory computer-readable medium of claim 9, further comprising:
detecting a position of a manipulated mechanical key of the input device when a key manipulation is performed;
judging whether or not the detected position of the manipulated mechanical key is close to the screen;
acquiring a time of the detection of the key manipulation when the detected position of the manipulated mechanical key is judged to be close to the screen; and
storing the acquired time in the memory.

11. The non-transitory computer-readable medium of claim 9, further comprising:
detecting a position of a manipulated software key displayed on the screen when a touch manipulation is performed;
judging whether or not the detected position of the manipulated software key is close to the mechanical keys; and
restricting acceptance of the touch manipulation according to a judgment result of the judged touch position.

12. The non-transitory computer-readable medium of claim 9, further comprising:
delaying acceptance of the touch manipulation by a second prescribed time;
judging whether or not the key manipulation is performed within the second prescribed time; and
restricting acceptance of the touch manipulation according to a judgment result.
